(19) United States
(12) Patent Application Publication
(10) Pub. No.: US 2010/0144296 A1
(43) Pub. Date: Jun. 10, 2010

(54) Carbon Nanotubes for Wireless Communication and Radio Transmission

(76) Inventors: Peter J. Burke, Irvine, CA (US); Christopher M. Rutherglen, Irvine, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/594,927

(22) PCT Filed: Apr. 11, 2008
(86) PCT No.: PCT/US08/60130

§ 371 Date: Oct. 6, 2009

Related U.S. Application Data
(60) Provisional application No. 60/911,475, filed on Apr. 12, 2007.

(51) Int. Cl. H04B 1/16

(52) U.S. Cl. 455/205; 977/742

(57) ABSTRACT

Described herein are systems and methods in which a carbon nanotube (CNT) is used as a demodulator of amplitude-modulated (AM) signals. Due to the nonlinear current-voltage (I-V) characteristics of a CNT, the CNT induces rectification of an applied RF signal enabling the CNT to function as a demodulator of an amplitude-modulated (AM) RF signal. By properly biasing the CNT such that the operating point is centered on the maximum portion of the I-V curve, the demodulation effect of the CNT can be maximized. The present invention is useful for possible nanoscale wireless communications systems, e.g., nanoscale radios.

### FIELD OF THE INVENTION

The present invention related to carbon nanotubes and, more particularly, to a carbon nanotube (CNT) used as a demodulator of amplitude-modulated (AM) signals.

### BACKGROUND INFORMATION

The use of carbon nanotubes (CNT) as components in high-frequency electronics has garnered much attention due to their favorably characteristics such as large mobilities, high transconductance, and long-free paths. Aside from the popular application of CNTs as high-frequency field effect transistors, other successful applications of CNTs include their use as RF detectors and mixers. Because of their electrical properties and very small dimensions, nanotubes are promising candidates for the realization of nanoscale devices.

### SUMMARY

Described herein are systems and methods in which a carbon nanotube (CNT) is used as a demodulator of amplitude-modulated (AM) signals. Due to the nonlinear current-voltage (I-V) characteristics of a CNT, the CNT induces rectification of an applied RF signal enabling the CNT to function as a demodulator of an amplitude-modulated (AM) RF signal. By properly biasing the CNT such that the operating point is centered on the maximum portion of the I-V curve, the demodulation effect of the CNT can be maximized. The present invention is useful for possible nanoscale wireless communications systems, e.g., nanoscale radios.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. It is also intended that the invention is not limited to require the details of the example embodiments.

### BRIEF DESCRIPTION OF THE FIGURES

The details of the invention, including fabrication, structure and operation, may be gleaned in part by study of the accompanying figures, in which like reference numerals refer to like segments.

FIG. 1 shows a test-setup demonstrating the use of a CNT as an amplitude modulated (AM) demodulator according to an exemplary embodiment.

FIG. 2(a) is a plot of the source-drain differential conductance vs gate (substrate) voltage of a semiconducting CNT.

FIG. 2(b) shows a current-voltage (I_{DS} vs V_{DS}) curve of the CNT.

FIG. 3(a) shows a comparison of demodulated current and |d²I/dV²| with respect to the bias voltage, V_{B}, showing a good match between the two.

FIG. 3(b) shows a linear modulation current detected by a lock-in amplifier across a 100 kΩ sense resistor, indicating that I is proportional to V_{RF}² (f=1 GHz, P=0 dBm, f_{mod}=13 Hz).

FIG. 4 shows demodulated current amplitude measured with respect to the modulated frequency (f=1 GHz, P_{wr}=−5 dBm, R=100Ω, V_{BB}=2 V) .

FIG. 5(a) shows a demodulated signal vs frequency, in which parasitic capacitance shorts the RF signal at frequencies>2 GHz.

FIG. 5(b) shows a schematic of an RF equivalent circuit.

FIG. 6 shows a CNT based radio according to an exemplary embodiment.

### DETAILED DESCRIPTION

Each of the additional features and teachings disclosed below can be utilized separately or in conjunction with other features and teachings to provide a carbon nanotube demodulator of an amplitude modulated (AM) radio signal. Representative examples of the present invention, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detail description may not be necessary to practice the invention in the broadest sense, and are instead taught merely to particularly describe representative examples of the present teachings.

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter.

The embodiments provided herein are generally directed to systems and methods in which a carbon nanotube (CNT) is used as a demodulator of amplitude-modulated (AM) signals. Experimental results demonstrating the use of CNTs as AM demodulators are presented followed by an exemplary CNT based radio capable of demodulating high-fidelity audio. The CNT based AM demodulator demonstrates the utility of nanotechnology in the wireless field.

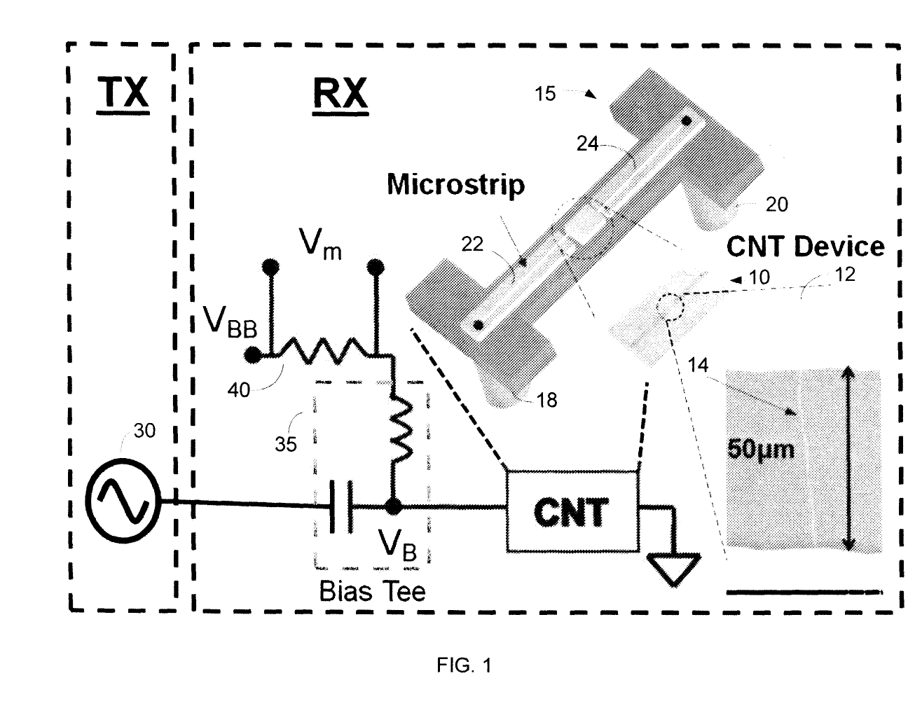

Experiments were conducted to demonstrate CNT based AM demodulators with modulation frequencies up to 100 KHz. FIG. 1 shows a schematic of the test-setup that was used for the experiments. The setup included the CNT device 10 being tested. A total of four devices 10 with semiconducting CNTs were tested.

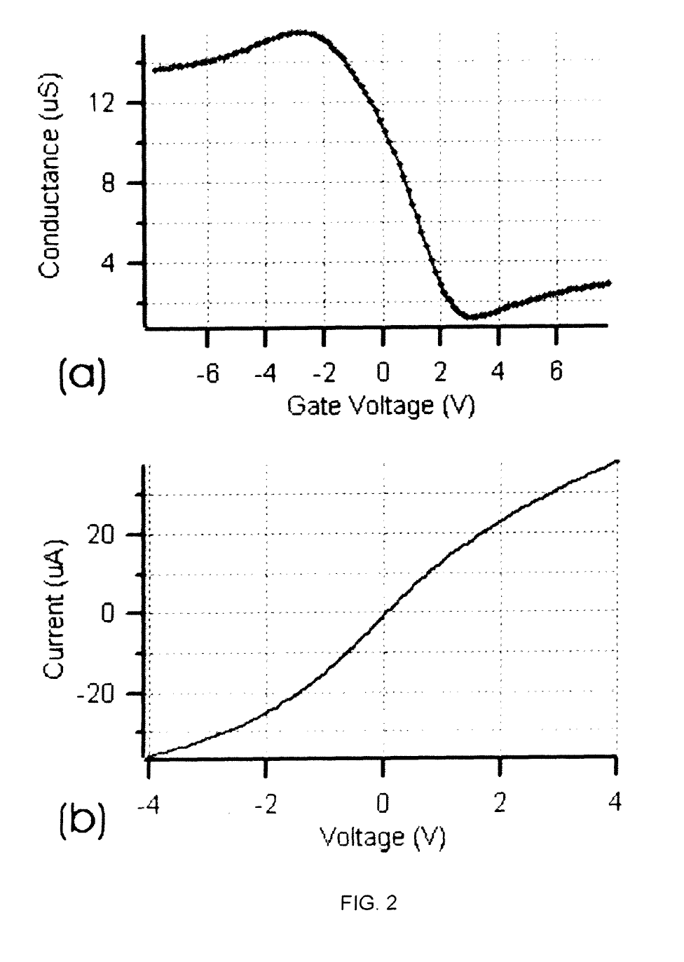

To fabricate the test devices 10, carbon nanotubes were synthesized on high resistivity Si wafers (>8000 Ωcm) to minimize the detrimental effect of parasitic capacitance at high frequencies. Using optical lithography, catalyst regions were patterned onto the wafer and after 1 h of sonication an aqueous solution of 100 mM FeCl₃ catalyst was applied for 10 s and rinsed with DI water. The nanotubes were synthesize using a CVD growth process described in detail in Z. Yu, S. Li, P. J. Burke, “Synthesis of aligned arrays of millimeter long, straight single walled carbone nanotubes,” Chem. Mater. 2004, 16(18), 3414-3416, and S. Li, Z. Yu, C. Rutherglen, P. J. Burke, “Electrical properties of 0.4 cm long single walled carbon nanotubes,” Nano Lett. 2004, 4(10), 2003-2007. Subsequent to nanotube growth, Pd (20 nm)/Au (80 nm) electrodes were evaporated onto the nanotubes with a gap-spacing of 50 μm and a width of 300 μm. Only samples with a single CNT bridging the gap were used in the experiments. An SEM image 12 of one of the nanotubes 14 under study is shown in FIG. 1. To perform high frequency measurements, the sample device 10 was incorporated on a microwave mount 15 with a pair of SMA connectors 18,20 and microstrip lines 22,24 connecting the device 10 as shown in FIG. 1. A total of four devices 10 with semiconducting CNTs were tested, and all were capable of acting as an AM demodulator. FIG. 2(a) shows a plot of the conductance vs. gate voltage of the semiconducting CNT under study.

To determine specific features of the nanotube's use as a demodulator, the test setup shown in FIG. 1 was used. An Agilent E4428C signal generator, with amplitude modulation, functioned as the RF source transmitter (TX) 30 and was feed through a MiniCircuits 0.1-6000 MHz bias tee 35 and into the sample device 10. Sinusoidal modulation frequencies of 0.1-100 kHz were used to amplitude modulate (AM) the RF carrier with an 80% modulation depth. The CNT 10 along with a sense resistor 40 and a lock-in amplifier (SR-810) (not shown in FIG. 1) functioned as the receiver (RX) in this setup. The voltage-drop across the sense resistor 40 was inputted to the lock-in amplifier. Extraction of the modulation signal from the RF carrier was performed by the CNT and the lock-in amplifier, which was tuned to the modulation frequency and used to measure the voltage-drop of the signal across the sense resistor 40.

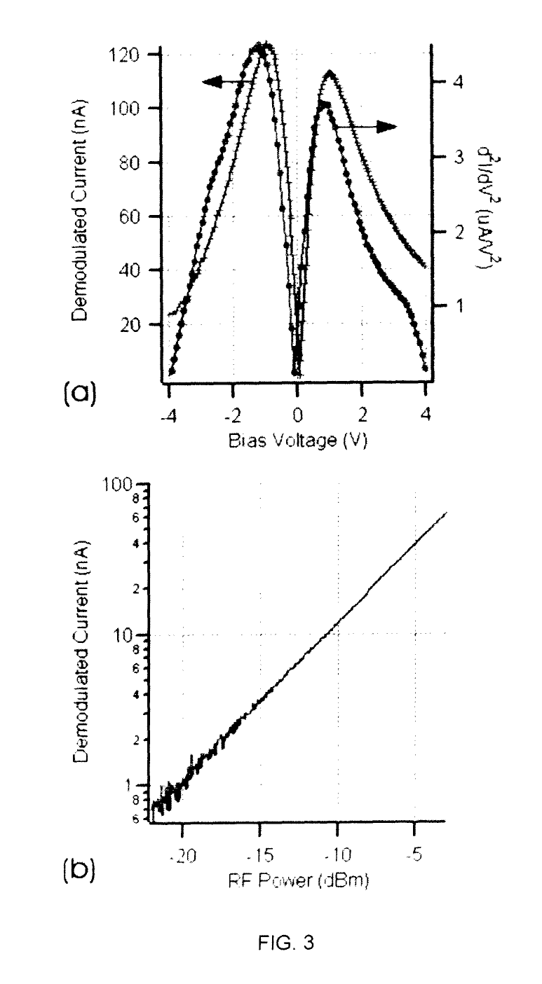

The CNT is capable of demodulating an amplitude modulated RF signal due to its nonlinear current-voltage (I_{Ds} vs V_{DS}) characteristics. It can be shown that such nonlinearities can rectify a portion of the applied RF current, which to the first order can be expressed as:

$$I = {I}_{0} \frac{1}{4} \frac{{d}^{2} I}{d {V}^{2}} {V}_{RF}^{2} \qquad Eq . ( 1 )$$

where the voltage of the applied RF signal is V_{RF}, and the second derivative represents the nonlinear current-voltage (I_{Ds} vs V_{DS}) characteristics of the CNT itself. We found the demodulated signal followed this relationship very well. Comparing the demodulated signal to the absolute value of the numerical second-derivative of the I-V trace shown in FIG. 2(b), we see in FIG. 3(a) that the two are nearly identical in form supporting that I_{rectified}∝d²I/dV². Further, the proportionality relationship between detected output signal and the applied RF power (which itself is proportional to V_{RF}²) was measured to be linear, indicating that I_{rectified}∝V_{RF}², as shown in FIG. 3(b).

Maximizing the demodulation signal can be achieved trough proper biasing of the CNT. As evident in FIG. 3(a), one can obtain maximum demodulation by biasing the CNT such that the operating point is centered on the maximum nonlinear portion of the I-V curve. Due to the inherent symmetry of the nanotubes, two such operating points exist at ±1 V. The maximum current responsivity was measured to be 125 nA/mW and was found to be independent of back-gate voltage.

Considering that the CNT resistance is on the order of 100 kΩ, from the RF point of view, a large impedance mismatch will exist between the CNT and the 50Ω characteristic impedance of the transmission line, resulting in a strong microwave signal reflection off the CNT. Because the power available from the source is P_{AVS}=V_{RF}²/8Z₀, and the RF voltage at the CNT is V_{RF} due to Z_{CNT}>>4, using eq. 1, we obtain I/ P_{AVS}=2(d²I/dV²)Z₀ for the responsivity of the CNT demodulator. The circuit for this analysis is presented in FIG. 5(b). This indicates that the resistance of the CNT is independent of the device's responsivity insofar as the second derivative of the CNT is the same. Taking the maximum measured value for the second-derivative as 4 μA/mW/V², one arrives at a responsivity of 400 nA/mW, which is comparable to the measured value of 125 nA/mW.

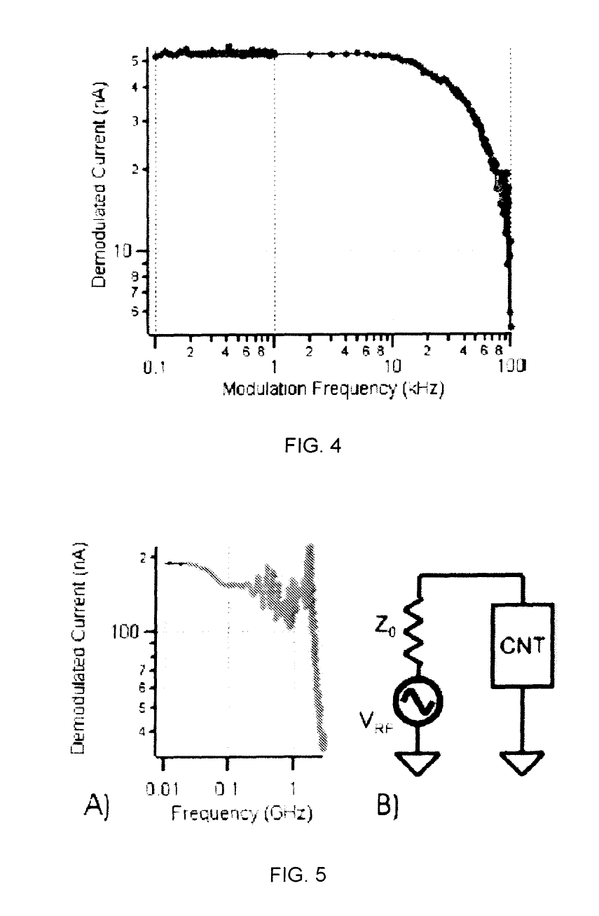

The effectiveness of the device at detecting the modulation signal up to 100 kHz was found to be limited by extrinsic parameters of the experimental setup and not due to the CNT itself. Due to capacitance within the bias tee and coax cable in conjunction with the sense resistor, an RC low-pass filter was established, thus giving a roll-off in the high audio frequency range of the demodulated signal. To minimize this effect, the sense resistor and the bias tee's capacitor were reduced to 100Ω and 100 pF, respectively. The roll-off was measured to have a −3 dB corner at 40 kHz, as shown in FIG. 4, which is well above the upper range of human hearing. Signal loss due to the inductor of the bias tee was measured to be −1.5 dB at 100 kHz, which is rather insignificant compared to the other sources of attenuation. As expected, at higher carrier frequencies (>2 GHz) the parasitic capacitance resulted in a strong degradation in the received signal, as shown in FIG. 5(a). This is predominately due to the relatively large contact pads used (300 μm×1000 μm).

Noise measurements were performed on the CNT demodulator system operating at a carrier frequency of 1 GHz and a bias voltage of 2.5 V. The system voltage-noise density, which includes noise from the lock-in amplifier, sense resistor, and CNT was measured to be 40×10⁻⁹(V/Hz^{1/2}) at an audio frequency of 1 kHz. Using the measured responsivity, β_{I}, of 125 nA/mW together with the device resistance of 100 kΩ, the noise-equivalent power (NEP) is calculated using NEP=υₙ/β_{I}R(W/Hz^{1/2}) and is 3 nW/Hz^{1/2}. This puts an upper limit on the noise equivalent power of the CNT itself

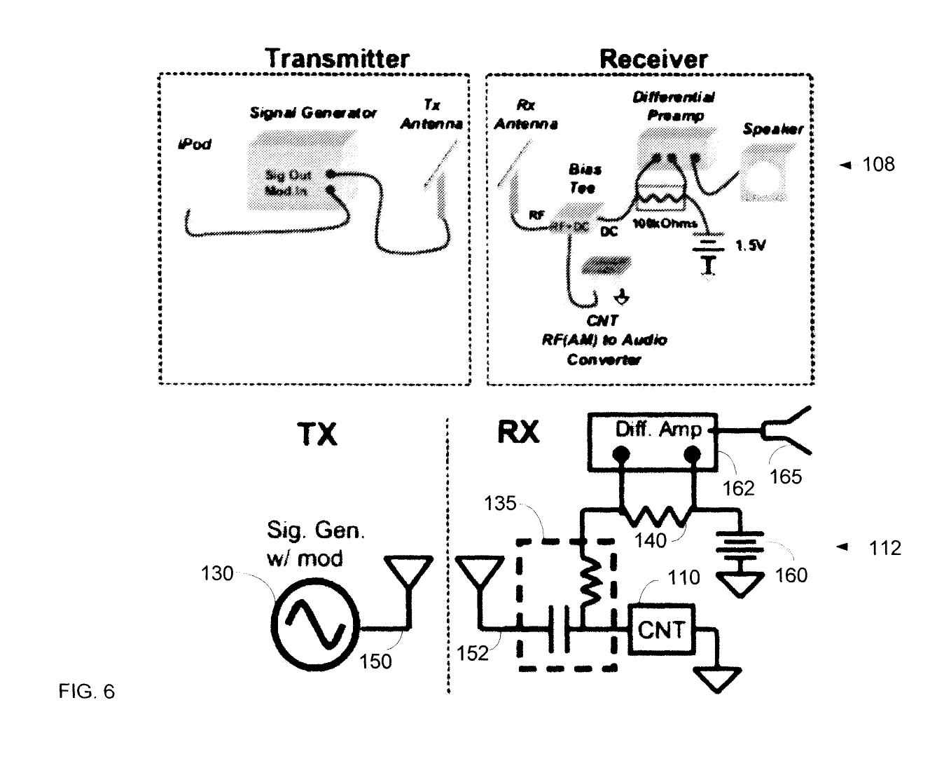

Utilizing the above documented effect, we demonstrated a simple design for a CNT based radio receiver. FIG. 6 shows a test setup 108 for the CNT radio as well as a schematic 112 of the CNT radio, according to an exemplary embodiment. In the test setup, the CNT was incorporated in the microwave mount. Here the carbon nanotube 110 functions in the critical role as the receiver's AM demodulator. The transmitter portion of the demonstration utilizes a signal generator 130 to create a 1 GHz RF signal that is externally amplitude modulated (AM) with music by an Ipod and fed to a dipole TX antenna 150 for wireless broadcast. On the receiver side, the RX antenna 152 picks up the 1 GHz RF signal, feeding it through the bias tee 135 and onto the carbon nanotubes 10 where it is rectified. The distance between the TX and RX antennas 150,152 was limited to ˜1m, but that can be improved by simply including a standard front-end preamplifier to boost the received signal before sending it on to the CNT for demodulation. A 1.5 V battery 160 is used to properly bias the CNT 110 for maximum demodulation. A differential pre-amplifier 162 then amplifies the voltage drop across the sense resistor 140, and the high-fidelity audio is fed to a speaker for audio broadcast 165. The audio-quality of the signal demodulated by the CNT was very clear and indistinguishable to the human ear from listening to the music directly. Although the exemplary CNT based radio was demonstrated for a signal amplitude modulated (AM) with audio, the CNT based radio can also be used for signals amplitude modulated with other data, e.g., digital data.

To predict how to optimize device performance as a function of length, one would need a quantitative and detailed theory of nanotube I-V curves and their nonlinearity. Although numerical simulation code exists that can predict nanotube I-V curves, a detailed study of the nonlinearity of CNTs as a function of length has not yet been preformed. In the absence of such studies, we may predict on the basis of general physical principles methods to optimize the CNT length to maximize the nonlinearity.

Considering that the nonlinearity in I-V originates from phonon scattering processes, one can further optimize the responsivity of the CNT demodulator by maximizing this nonlinear influence. In general, this can be accomplished by decreasing the length of the nanotube to an optimum value. Depending whether one is in the low or high voltage regime, the dominate scattering mechanism would be acoustic phonon scattering or optical phonon scattering, respectively. In the limit of each of these regions the slope of the nanotube's I_{DS} vs V_{DS} curve can be expressed as G=(4e²/h)×1ᵢ(lᵢ+L), where L is the nanotube length and lᵢ equals lₐₚ˜300 nm for acoustic phonon scattering in the low bias regime and lₒₚ˜15 nm for optical phonon scattering in the high bias voltage regime. The nonlinearity manifests as the bias voltage transitions from a region with one dominated scattering mechanism to the other, which in general can be maximized by considering what length nanotube, L, would result in the greatest difference in the slope of the I-V between the two regions. For example, if we consider the mean-free-path lengths stated above to be generally accurate, the difference in the sloped is maximized when the nanotube length is ˜100 nm. If the nanotube length is decreased further, ballistic transport dominates and the nonlinearity in I-V is again reduced. For long nanotubes (>10 μm) other scattering processes would become significant such as defect induced elastic scattering, which further complicates the analysis. Other mechanism typically responsible for nonlinear I-V characteristics such as Schottky barrier at the contacts were of negligible contribution due to the use of Pd ohmic contacts. Furthermore, because both metallic and semiconducting CNTs display this behavior, these scaling arguments could be applied to both cases. Thus, although the observed nonlinearity is rather mild, it can be dramatically improved through careful optimization.

Therefore, we have successfully demonstrated and analyzed the use of a carbon nanotube to demodulate an amplitude modulated (AM) signal in a radio receiver. The nanotube demodulator demonstrates that a critical component (the demodulator) of a radio receiver can be realized on a nanoscale using a nanotube, providing an important step to the realization of a truly nanoscale wireless communications system.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the spirit and scope of the appended claims.

What is claimed is:

1. A method for demodulating an amplitude modulated (AM) signal comprising:
applying the AM signal to a carbon nanotube to produce a demodulated signal; and
amplifying the demodulated signal.

2. The method of claim 1, further comprising feeding the amplified demodulated signal to a speaker.

3. The method of claim 1, further comprising voltage biasing the carbon nanotube.

4. The method of claim 3, wherein the carbon nanotube is biased at a bias voltage that is centered on a maximum nonlinear portion of a current-voltage (I-V) curve of the carbon nanotube.

5. The method of claim 1, wherein the amplitude modulation is within a frequency range of up to 100 kHz.

6. An amplitude modulated (AM) radio receiver comprising:
an antenna;
an AM demodulator coupled to the antenna, the AM demodulator comprising a carbon nanotube; and
an amplifier coupled to the AM demodulator.

7. The radio receiver of claim 6, further comprising a bias voltage source for biasing the carbon nanotube.

8. The radio receiver of claim 7, wherein the bias voltage source biases the carbon nanotube at a bias voltage that is centered on a maximum nonlinear portion of a current-voltage (I-V) curve of the carbon nanotube.

9. The radio receiver of claim 6, further comprising a speaker coupled to an output of the amplifier.

10. The radio receiver of claim 6, further comprising a sense resistor coupled to the nanotube for sensing a demodulated signal, wherein the amplifier is configured to amplify a voltage drop across the sense resistor.
